(19) United States
(12) Patent Application Publication
(10) Pub. No.: US 2002/0038290 A1
(43) Pub. Date: Mar. 28, 2002

(54) Digital notary system and method

(76) Inventors: Jeffrey M. Cochran, Seattle, WA (US); Mir Hajmiragha, Bellevue, WA (US)

Correspondence Address: David A. Lowe, Esq., BLACK LOWE & GRAHAM PLLC, 816 Second Avenue, Seattle, WA, 98104, US

(21) Appl. No.: 09/907,723

(22) Filed: Jul. 17, 2001

Related U.S. Application Data
(60) Provisional application No. 60/235,408, filed on Sep. 22, 2000.

(51) Int. Cl. G06F 17/60

(52) U.S. Cl. 705/50

(57) ABSTRACT

A digital signature notarization system and method for notarizing an electronic document at a remote computer coupled to a computer server over a network. A signatory enters an identification code at the remote computer for gaining access to the computer server over the network. A notary observes the entry of the identification code. An electronic document requiring a notarized signature by the signatory is retrieved from the server. The notary verifies that the signatory is the proper signatory. The notary generates a digital signature for the retrieved electronic document according to the verification and the observation. Next, an electronic document indicating the notary's actions is generated and the notary generates a digital signature for the electronic document indicating the notary's actions. The generated digital signature of the notary for the retrieved electronic document and the generated electronic document indicating the notary's actions are transmitted to the server over the network.

### PRIORITY CLAIM

This application claims priority from Provisional Application filed Sep. 22, 2000, Serial No. 60/235,408, Attorney Reference No. ASTS-1-1005.

### FIELD OF THE INVENTION

This invention relates to digital signatures, and more particularly, to notarizing digital signatures in documents.

### BACKGROUND OF THE INVENTION

Mechanisms exist for creating legally binding written instruments. One such mechanism is the application of a handwritten signature to a written document. For certain transactions, authentication of a handwritten signature, for example by a licensed public official such as a notary, is required. Authentication of a signature by a notary requires a personal appearance before the notary. The notary personally witnesses the execution of the signature, inspects identity documents to verify the identity of the person executing the signature, and affixes a notary statement and seal to the signed document. Notarization of a signature provides a level of assurance that the written instrument was in fact executed by the person identified by the signature, and prevents repudiation of the signed instrument by the signer.

Electronic, computer based methods of doing business are increasingly displacing traditional paper based methods. Electronic communications and electronic documents are replacing written contracts, orders, payment instruments, account statements, invoices, and other paper documents.

Digital encryption, digital message digests, digital signatures, and digital certificates are some of the existing cryptographic tools that are used in the present invention to address the need for creating and authenticating legally binding electronic documents and communications. One of the purposes of a digital signature is to link an electronic document with an owner of a private key corresponding to a particular public key. Additionally, a digital signature can be used to determine whether an electronic document has been altered during transmission of the document from the sender to the recipient.

Digitally signing an electronic document provides an acceptable tool for applying a signature to a document. Some are trying to provide notarization of electronic documents in order to comply with standard notarization requirements. In one application, a client conveys an unsigned electronic document stored on a storage media to an authorized electronic document authenticator. The client presents identity documents to the authenticator to verify the client's identity. The client digitally signs the electronic document in the presence of the authenticator. The authenticator verifies the digital signature using the public key provided by the client. Having witnessed the client digitally signing the electronic document using the client's private key, having verified that the public key supplied to the authenticator by the client corresponds to the private key used by the client to produce the digital signature, and having verified the identity of the client using the identification documents provided by the client, the authenticator appends an “authenticator identification envelope” containing a certification to that effect to the electronic document. The authenticator digitally signs the authenticator identification envelope, thereby creating an authenticated electronic document. The authenticator transfers the completed, authenticated electronic document onto transportable storage media and returns it to the client. The client then returns to their system and transmits the signed document and the authenticated document to the receiving party. This application requires a significant amount of time to complete. The client must travel to an authenticator with the document on disk, get it authorized and then return to their computer system for delivery of the authenticated, signed document.

Accordingly, there remains a need for making the notarization of electronic documents a more efficient, real-time procedure.

### SUMMARY OF THE INVENTION

The present invention is a digital signature notarization system and method for notarizing an electronic document at a remote computer coupled to a computer server over a network. The method includes a signatory entering an identification code at the remote computer for providing access to the computer server over the network. A notary observes the entry of the identification code. An electronic document requiring a notarized signature by the signatory is retrieved from the server. The notary verifies that the signatory is the proper signatory. Then, the notary generates a digital signature, using an authoritative electronic signature, for the retrieved electronic document according to the verification and the observation. The authoritative electronic signature is an electronic signature issued and verified by a certification server under control of a government agency, certificate authority, or the organization accepting the electronic document as a legally binding document. The authoritative electronic signature is verified prior to use by the certification server. Next, an electronic document indicating the notary's actions is generated and the notary generates a digital signature for the electronic document indicating the notary's actions. The generated digital signature of the notary for the retrieved electronic document and the generated electronic document indicating the notary's actions are transmitted to the document server over the network.

In accordance with other aspects of the present invention, verifying that the signatory is the proper signatory includes receiving at the remote computer digital certification information from the server. The digital certification information is associated with the proper signatory. The received digital certification information is presented to the notary. The notary compares the presented digital certification information to identification of the signatory in order to verify the signatory is the proper signatory.

As will be readily appreciated from the foregoing summary, the invention provides an improved digital notarization system and method.

### BRIEF DESCRIPTION OF THE DRAWINGS

The preferred embodiment of this invention is discussed in detail below with reference to the following drawings.

FIG. 1 is a block diagram showing components of the present invention; and

FIG. 2 is a flow diagram illustrating a preferred process performed by the components illustrated in FIG. 1.

### DETAILED DESCRIPTION OF THE PREFERRED EMBODIMENT

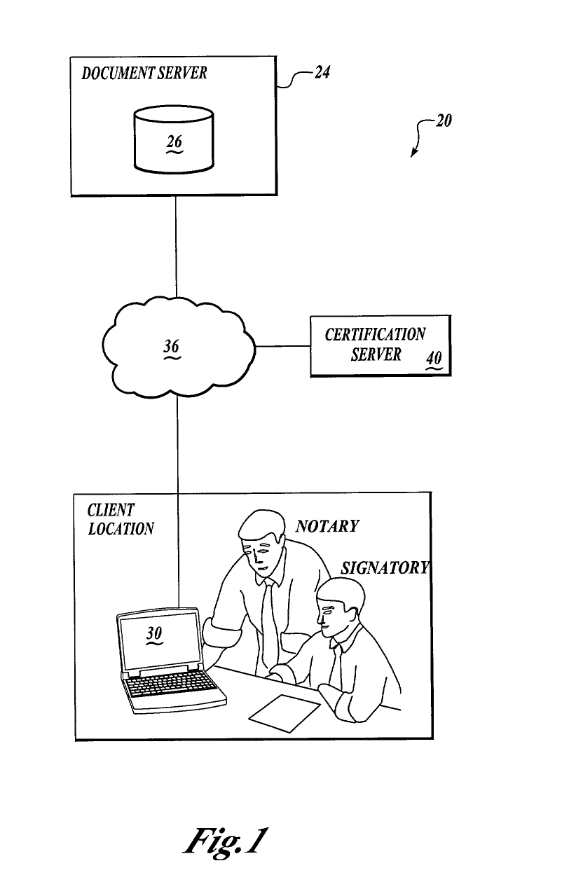

The present invention is a system and method for notarizing electronic documents. As shown in FIG. 1, an example system 20 of the present invention includes a document server 24 with a database 26 coupled to a plurality of client systems 30, and at least one certification server 40 across a public or private network 36. Network 36 is a landline network, a wireless network, or a combination of both a landline and wireless network. Client system 30 is a stationary computer-based device, such as a personal computer, or a portable device, such as a laptop, a personal data assistant (PDA), a cellular phone, or other device with mobile capabilities. Client system 30 includes a network browser application for allowing interaction with data transmitted to and from document server 24 over network 36.

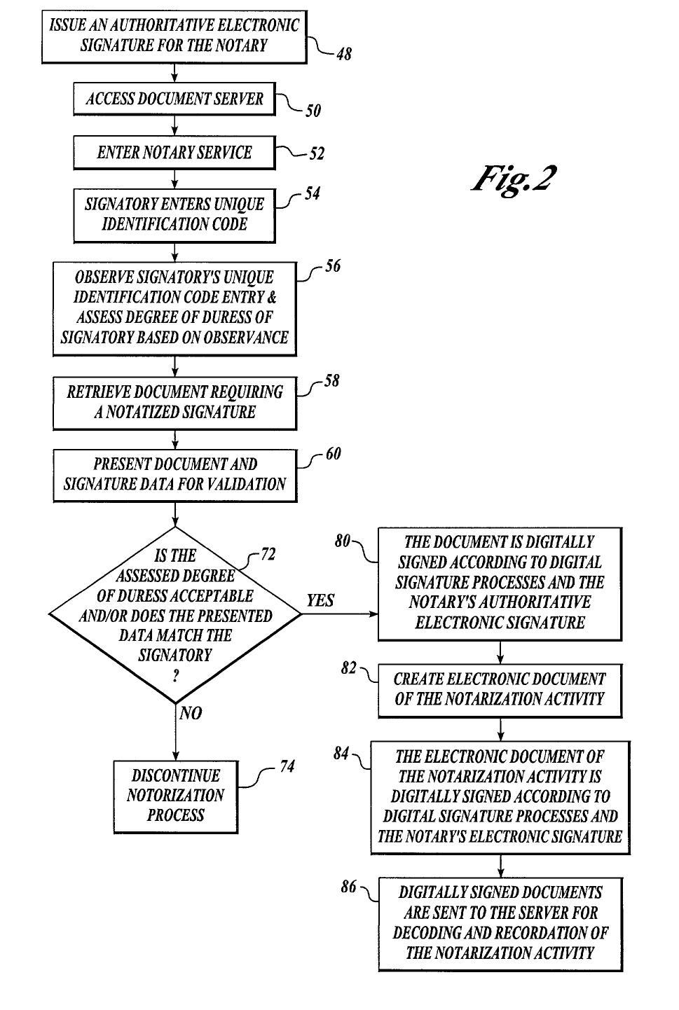

The preferred operation of the present invention is better understood with further reference to FIG. 2. A signatory and a notary (or another with previously approved authorization authority) are simultaneously present at client system 30 to interact with information saved at and organized by server 24. The information is preferably presented to the client system and by the browser application. The notary is a person with previously approved notarization authority as identified by document server 24. The notary has access to registration information stored in database 26.

At block 48, an authoritative electronic signature is verified by a certification server under control of a government agency, certificate authority, or an organization accepting the electronic document as a legally binding document and is issued to the notary. The authoritative electronic signature is verified prior to use by the certification server 40.

At block 50, the notary accesses document server 24 using client system 30 over network 36. The notary enters a previously assigned personal identification alpha-numeric that unlocks documents requiring notarization, thereby giving the notary access to the document and related signature stream data (certificate data). In one embodiment, document server 24 generates interactive web pages that are downloaded in packets over network 36 (e.g. Internet) according to requests generated at client system 30. The requests are routed through network 36 to document server 24. Access to server 24 is preferably password protected.

At block 52, the signatory and the notary enter a notarizing web page. At the notarizing web page, the signatory enters a previously assigned unique identification code, or personal identification number (PIN) (block 54). At block 56, while the signatory enters their unique identification code, the notary observes the signatory's unique identification code entry and assesses the degree of duress of the signatory. At block 58, the signatory or notary retrieves any documents assigned to the signatory that require a notarized signature. The documents requiring notarized signatures are electronic documents that have been registered by another at server 24. Next, at block 60, the notary presents document and signature data pertaining to the signatory's identity for validation. The presented data preferably includes information such as previously generated digital certificate information stored in database 26 of document server 24. At decision block 72, the notary determines if the assessed degree of duress is acceptable and if the presented data matches the signatory. Preferably, the acceptability of an assessed degree of duress might be based on a list of unacceptable body motions or vocal traits, or just the observation experience of the notary. In order to determine if the presented data matches the signatory, the notary may ask the signatory for positive identification.

If the notary does not attain a match between the presented data and the signatory, or the notary observes that the signatory appears to exhibit a level of distress greater than what the notary believes is acceptable (i.e., the notary has a strong suspicion the signatory is not who they say they are), the notarization process is discontinued (block 74). If the notary attains a match between the presented data and the signatory and the notary observes that the signatory appears to exhibit a level of distress that the notary believes is acceptable, the document is digitally signed according to digital signature practice with the notary's electronic signature (block 80). At block 82, an electronic document of the notarization activity is created. The document of the notarization activity is preferably an extensible markup language (XML) document. At block 84, the electronic document of the notarization activity is digitally signed according to digital signature practice with the notary's electronic signature. At block 86, the digitally signed documents are sent over network 36 to server 24 for decoding and recordation of the notarization activity.

While the preferred embodiment of the invention has been illustrated and described, it will be appreciated that various changes can be made without departing from the spirit and scope of the invention. For example, the order of some of the steps of the described methodology may be altered without affecting the functionality of the present invention. Accordingly, the scope of the invention is not limited by the disclosure of the preferred embodiment. Instead, the scope of the invention should be determined entirely by reference to the claims that follow.

The embodiments of the invention in which an exclusive property or privilege is claimed are defined as follows:

1. A method for notarizing an electronic document at a remote computer coupled to a computer server over a network, the method comprising:
entering an identification code by a signatory at the remote computer for accessing the computer server over the network;
observing the signatory's entry of the identification code;
retrieving an electronic document from the server, wherein the electronic document requires a notarized signature by the signatory according to a previously assigned requirement;
verifying that the signatory is the proper signatory;
generating a digital signature of the notary for the retrieved electronic document according to the verification and the observation;
generating an electronic document indicating the notary's actions;
generating a digital signature of the generated electronic document indicating the notary's actions; and
transmitting the generated digital signature of the notary for the retrieved electronic document and the generated electronic document indicating the notary's actions to the server over the network.

2. The method of claim 1, wherein verifying comprises:
receiving digital certification information from the server, the digital certification information being digital certification information associated with the proper signatory,
presenting the received digital certification information at the remote computer, and
comparing the presented digital certification information to identification of the signatory for verifying that the signatory is the proper signatory.

3. The method of claim 1, wherein generating a digital signature of the notary for the retrieved electronic document comprises generating a digital signature of the notary using an authoritative electronic signature issued and verified by a certification server.

4. The method of claim 3, wherein the certification server is operated by at least one of a government agency, a certificate authority, or an organization authorized to receive legally binding documents.

5. A system for notarizing an electronic document over a network, the system comprising:
a remote computer comprising a processor and memory, the processor comprising:
a user interface component configured to access the computer server over the network, enter an identification code by a signatory, retrieve an electronic document from the server, and present a portion of digital certificate information previously generated for the signatory, wherein the retrieved electronic document requires a notarized signature by the signatory according to a previously assigned requirement;
a first digital signature component configured to allow a notary having witnessed the signatory's entry of the identification code to generate a digital signature for the retrieved electronic document according to the witnessed entry and to allow verification by the notary of the signatory with respect to the presented digital certificate information;
a notarization document generating component configured to generate an electronic document based on the actions performed by the user interface component and the first digital signature component;
a second digital signature component configured to allow the notary to generate a digital signature for the generated electronic document based on the actions performed by the user interface component and the first digital signature component; and
a transmission component configured to transmit the products of the first and second digital signature components; and
a server comprising a processor and memory, the processor comprising:
a reception component configured to receive the transmitted products of the first and second digital signature components of the remote computer;
a decoder component configured to decode the received products; and
a storage component configured to store the results of the decoder component, previously registered documents, and digital certificate information for previously registered signatories and notaries.

6. The system of claim 5, wherein the first digital signature component generates a digital signature of the notary using an authoritative electronic signature issued and verified.

7. The method of claim 6, wherein the authoritative electronic signature is issued and verified by at least one of a government agency, a certificate authority, or an organization authorized to receive legally binding documents.

8. A system for notarizing an electronic document at a remote computer coupled to a computer server over a network, the method comprising:
a means for entering an identification code by a signatory at the remote computer for accessing the computer server over the network;
a means for observing the signatory's entry of the identification code;
a means for retrieving an electronic document from the server, wherein the electronic document requires a notarized signature by the signatory according to a previously assigned requirement;
a means for verifying that the signatory is the proper signatory;
a means for generating a digital signature of the notary for the retrieved electronic document according to the verification and the observation;
a means for generating an electronic document indicating the notary's actions;
a means for generating a digital signature of the generated electronic document indicating the notary's actions; and
a means for transmitting the generated digital signature of the notary for the retrieved electronic document and the generated electronic document indicating the notary's actions to the server over the network.

9. The system of claim 8, wherein the means for verifying comprises:
a means for receiving digital certification information from the server, the digital certification information being digital certification information associated with the proper signatory;
a means for presenting the received digital certification information at the remote computer; and
a means for comparing the presented digital certification information to identification of the signatory for verifying that the signatory is the proper signatory.

10. The system of claim 8, wherein the means for generating a digital signature of the notary for the retrieved electronic document generates a digital signature of the notary using an authoritative electronic signature issued and verified.

11. The method of claim 10, wherein the authoritative electronic signature is issued and verified by at least one of a government agency, a certificate authority, or an organization authorized to receive legally binding documents.
